(19) United States
(12) Patent Application Publication
(10) Pub. No.: US 2008/0298473 A1
(43) Pub. Date: Dec. 4, 2008

(54) Methods for Parallel Deblocking of Macroblocks of a Compressed Media Frame

(75) Inventor: Dayin Gou, San Jose, CA (US)

Correspondence Address: Venture Pacific Law, PC, 5201 Great America Parkway, Suite 270, Santa Clara, CA, 95054, US

(73) Assignee: Augusta Technology, Inc., Santa Clara, CA (US)

(21) Appl. No.: 12/129,642

(22) Filed: May 29, 2008

Related U.S. Application Data
(60) Provisional application No. 60/941,640, filed on Jun. 1, 2007.

(51) Int. Cl. H04N 7/26; H04B 1/66; H04N 7/12

(52) U.S. Cl. 375/240.29; 375/240.24; 382/268; 375/E07.027; 375/E07.093; 375/E07.19

(57) ABSTRACT

This invention relates to methods for the parallel deblocking of macroblocks of a compressed media frame, such as a frame from a compressed video stream, to smooth out artifacts and discontinuities caused by the compression of the media. These methods for parallel deblocking of a frame having a plurality of tiles wherein each tile having a data dependency on zero or more of said tiles, comprising the steps of: constructing a reference deblocking sequence for the processing of said tile as a function of the data dependency of each respective tile; calculating scheduling indices for said tiles as a function of said reference deblocking sequence; and deblocking said tiles in accordance with said scheduling indices.

### CROSS REFERENCE

This application claims priority from a provisional patent application entitled “Methods for the Parallel Deblocking of Macroblocks or Macroblock Pairs” filed on Jun. 1, 2007 and having an Application No. 60/941,640. Said application is incorporated herein by reference.

### FIELD OF INVENTION

This invention relates to methods for the parallel deblocking of macroblocks or macroblock pairs of a compressed media frame, such as a frame from a compressed video stream, and, in particular, to methods for parallel deblocking of macroblocks or macroblock pairs of a compressed media frame to smooth out artifacts and discontinuities caused by the compression of the media.

### BACKGROUND

Advances in video compression techniques have revolutionized the way video information is transmitted, received, stored and displayed. Applications that use video compression include broadcast television and home entertainment including high definition television and other forms of video devices including those that can exchange digital video information such as computers, DVD players, gaming consoles and systems, and wireless devices. These applications and many more are made possible by video compression technology.

Generally, compression allows video content to be transferred and stored using much lower data rates while still providing desirable frame quality, e.g., providing relatively pristine video at low data rates or at rates that use less bandwidth. To this end, compression identifies and eliminates redundancies in a signal to produce a compressed bit stream and provides instructions for reconstructing the bit stream into a frame when the bits are decompressed.

Video compression techniques may introduce artifacts or discontinuities that need to be filtered or corrected to decode the compressed video to near its original state. Most video compression standards, including the H.264, divide each input field or frame into blocks or macroblocks (“MB”) of fixed size. Generally, a MB is a 16×16 block of luma samples and two corresponding blocks of chroma samples. Pixels within these macroblocks are considered as a group without reference to pixels in other macroblocks. Compression may involve the transformation of the pixel data of each block or macroblock into a spatial frequency domain. The compression of separate macroblocks can create coding artifacts at the block and macroblock boundaries since the adjacent macroblocks may be encoded differently. Thus, the image may not mesh well at the macroblock boundary.

Deblocking, which may be performed as a part of the decoding process of a video transmission, removes the blocking artifacts caused by the transform coefficients quantization during video decompression. In standards such as MPEG-1, MPEG-2, and MPEG-4, this process was optional since it did not affect the decoding of a video transmission. In contrast with the other MPEG standards, deblocking in the H.264 standard is not an optional feature of the decoder. It is mandatory for the decoder if the encoded signals require it. Therefore, deblocking becomes a necessary step in the decoding process.

Deblocking is time-consuming. Moreover, with the H.264 standard, it is necessary to deblock in the decoding process and in the encoding process because deblocking is in-loop for both of these processes. The exact percentage of the processing time that is used for deblocking may vary depending on the media stream. However, it is quite common that deblocking can account for 20% to 30% of the total decoding computation.

In order to reduce the time needed to complete the deblocking process, parallel deblocking schemes may be implemented. Parallel deblocking can mean the deblocking of one or more tiles at approximately the same time, where a tile may be defined as one or more macroblocks, one or more macroblock pairs, or other types of partitions for a frame.

In very limited circumstances, different slices of a decoded frame can be processed in parallel. For example, parallel processing can occur in profiles where flexible macroblock ordering (“FMO”) is not supported and the disable_deblocking_filter_idc is equal to 2. However, in general, deblocking should be conceptually performed on a macroblock basis for the entire decoded frame in the macroblock address order, i.e., approximately from a left tile to a right tile and from the top row down to the bottom row, starting with the macroblock in the top-left corner. For instance in FIG. 1, the tiles are deblocked in order from the top-left corner, Tile 1, to the top-right corner, Tile 10, then from the next row down, Tile 11, and back to the right, Tile 21, until all the rows have been deblocked. In Macroblock-Adaptive Frame-Field Coding (“MBAFF”) streams, deblocking for MBAFF streams are done on MB pairs since the MB addresses of the two vertically contiguous MBs in a MB pair are always contiguous. A MB Pair is a pair of vertically contiguous macroblocks in a frame that is coupled for use in MBAFF decoding.

Parallel processing at slice level, even when possible, is non-trivial due to the data dependency existing in deblocking. As stated earlier, slice level parallel deblocking is impossible where the disable_deblocking_filter_idc is not equal to 2 or where FMO exists in the stream in extended profile. In addition, since an entire frame is sometimes encoded as only 1 slice, parallel processing of the slices may not be possible.

Even if pipelines may be used to interleave deblocking processing with inverse transform or motion compensation, it may still not meet the real time requirement of some applications. A portable device where power consumption is a major concern and the main frequency of the device cannot run high is such an example.

Therefore, it is desirable to identify and utilize methods for parallel processing schemes that can speed up the deblocking process, as well as meet the overall application specific requirements.

### SUMMARY

An objective of the methods of this invention is to provide methods for the parallel processing of tiles by utilizing data dependencies between the tiles.

Another objective of the methods of this invention is to reduce resource hardware idling by dynamically scheduling the deblocking of the tiles.

The present invention relates to methods for the parallel deblocking of macroblocks or macroblock pairs of a compressed media frame, such as a frame from a compressed video stream, to smooth out artifacts and discontinuities caused by the compression of the media. These methods for parallel deblocking of a frame having a plurality of tiles wherein each tile having a data dependency on zero or more of said tiles, comprising the steps of: constructing a reference deblocking sequence for the processing of said tile as a function of the data dependency of each respective tile; calculating scheduling indices for said tiles as a function of said reference deblocking sequence; and deblocking said tiles in accordance with said scheduling indices.

An advantage of this invention is that the tiles of a frame can be deblocked in parallel, thus reducing the total amount of time to deblock a frame having one or more tiles.

Another advantage of this invention is that dynamic scheduling for deblocking of the plurality of tiles of a frame reduces hardware resource idling, and thus increases efficiency in deblocking of the tiles.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a sequential deblocking order of a 9×11 frame by a prior art method under the H.264 standard.

FIG. 2 illustrates the data dependency of the tile, T_{j,i}, on three other tiles, T_{j,i-1}, T_{j-1,i}, and T_{j-1,i+1} of a frame with n×m tiles.

FIG. 3 illustrates the reference deblocking sequence for a frame with 9×11 tiles.

FIG. 4 illustrates a diagonal row of tiles of a 9×11 frame that may be deblocked in parallel by a method of this invention.

FIG. 5 illustrates a scheduling index for a frame with 9×11 tiles, where one or more hardware resources may deblock the tiles in the order starting from the smallest number to the highest.

FIG. 6 is a process flow for a method of this invention for statically scheduling the parallel deblocking of the tiles of a frame.

FIGS. 7a-7b are a process flow for a method of this invention for dynamically scheduling the parallel deblocking of the tiles of a frame.

### DESCRIPTION OF THE PREFERRED EMBODIMENTS

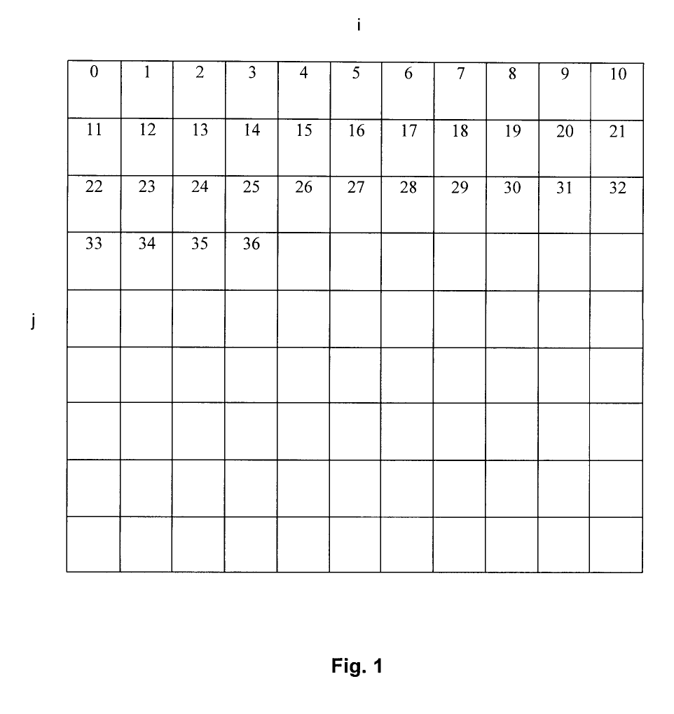

The presently preferred embodiments of the present invention provide methods for the parallel deblocking of the tiles of a frame utilizing the data dependency between tiles. A frame may be herein defined to mean an image captured at some instant in time or a field, such as, but not limited to, a predictive picture. Data dependency between a current tile and a neighbor will be herein described. FIG. 1 is an illustration of the processing order for the deblocking of the tiles of a frame defined under the H.264 standard. The frame has 9×11 tiles wherein each tile is labeled with the H.264 standard defined deblocking order. Here, the tiles are deblocked sequentially, one after another, where the current tile being deblocked can be herein referred to as the current tile. Since the tiles are deblocked sequentially, Tile 36 should not be deblocked until Tile 0 through Tile 35 have been deblocked.

A method of this invention can deblock multiple tiles in parallel at approximately the same time by taking advantage of the fact that the current tile being deblocked will only need external pixels from some of its neighboring tiles, also referred to as adjacent tiles, on top or to its left, but not all the previously deblocked tiles. For instance in FIG. 1, if Tile 36 is the current tile, it will only need external pixels from Tile 25 on top and Tile 35 to the left. Since the deblocking of Tile 26 may affect some pixels of Tile 25 in Tile 25's bottom right corner, the deblocking of Tile 36 should not occur until after Tile 26 has been deblocked. The deblocking of Tile 36 does not need information directly from pixels of other tiles such as those from Tile 10, Tile 20, or Tile 30. However, it may need indirect pixel information from other tiles since deblocking Tile 25 will require pixel information from Tile 24, Tile 14, and Tile 15.

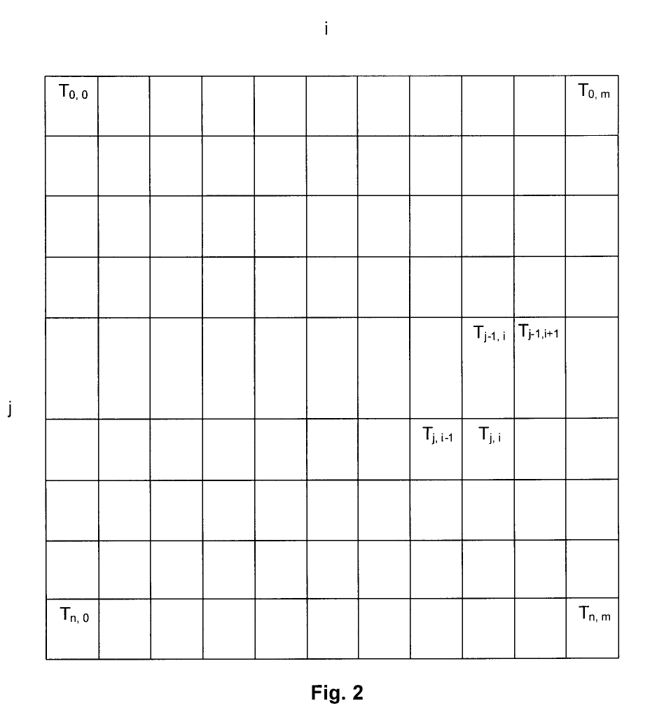

Except for the tiles on a frame boundary, in general, a current tile is ready for deblocking if three of its neighboring tiles, namely, the tile on the top of said tile, the tile on the top right of said tile, and the tile to the left of said tile have been deblocked. For instance, FIG. 2 illustrates a frame with n×m tiles where T_{j,i} indicates the tile on the jth row and the ith column of the frame, if T_{j,i} is a current tile, then T_{j,i} is directly data dependent on the external pixel data of the following deblocked tiles: T_{j-1,i}, T_{j-1,i+1}, and T_{j,i-1}, if these tiles exist. Therefore, the current tile T_{j,i} is ready to be deblocked once its three neighboring tiles T_{j-1,i}, T_{j-1,i+1}, and T_{j,i-1} have been deblocked.

The T_{j,i} nomenclature may be herein used to describe a location of a tile in a frame, where j is the row position of the tile and i represents the column position of the tile. The rows are numbered from top to bottom starting at zero and in ascending integer order. The columns are numbered from left to right starting at zero and in ascending integer order. For instance in FIG. 2, the tile on the top left corner is T_{0,0} since it is located in row 0 and column 0. Likewise, the tile on the bottom right corner is T_{n,m} since it is located in the n row and m column. The T_{j,i} nomenclature will be used to refer to the location of tiles of the frames illustrated in FIG. 1 through FIG. 5.

For a current tile on the boundary of a frame, the current tile may be data dependent on less than three tiles. For instance, tile T_{0,0} of FIG. 2 is data dependent on zero tiles since there are no adjacent tiles on the left or to the top of that tile. The other tiles in the same column as T_{0,0}, namely those tiles where i=0, can only be data dependent on two tiles since there are no tiles to the left of this column.

Recognizing the data dependency of the tiles of a frame may imply that not all the tiles have to be deblocked sequentially and that some tiles can be deblocked in parallel. A reference deblocking time for each tile indicating the earliest time unit that a tile can be deblocked can be constructed as a function of the data dependency for each tile (if there are no hardware resource limitations).

Hardware resources may be implemented by software with a multi-processor environment or by specially designed hardware such that deblocking can occur in parallel. The amount of hardware resources that are available and the inter-tile data dependency limit the number of tiles that can be deblocked in parallel. Where multiple hardware resources are available, each hardware resource may be defined to work on a different tile at any one specific time. A hardware resource will be idle when no tiles are available. This usually happens at the beginning or ending of deblocking a frame. The dynamics of scheduling tiles to different hardware resources can also result in the idling of a hardware resource.

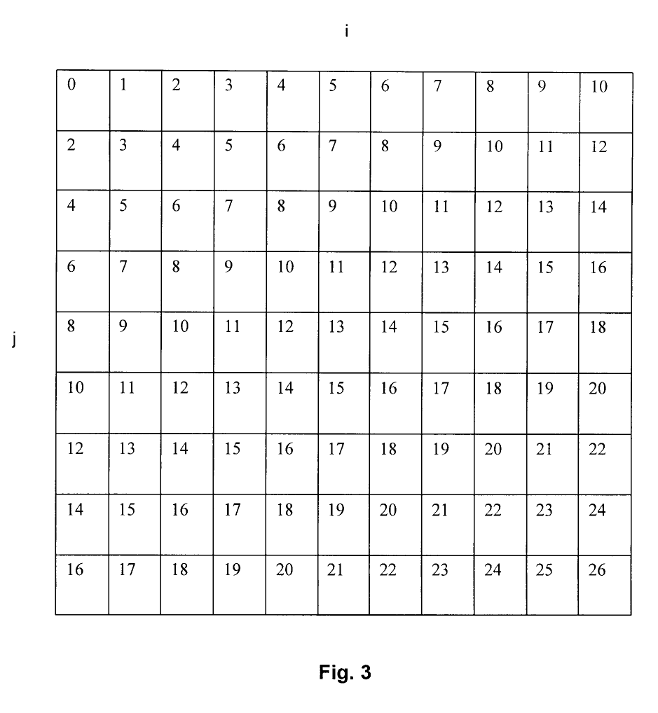

FIG. 3 illustrates a reference deblocking sequence for deblocking tiles in a frame with 9×11 tiles, where each tile is represented by a rectangular block. An integer time unit of “1” can be defined to be the time needed for deblocking a tile. The number in each tile represents the reference deblocking time for that tile, i.e., the earliest time that the tile can be deblocked if there are no hardware resource limitations.

At time=0, only T_{0,0} is deblocked since it is not data dependent on any other tile.

At time=1, T_{0,0} has been deblocked. T_{0,1} can now be deblocked since it is the only tile that is data dependent on T_{0,0}.

At time=2, T_{0,0} and T_{0,1} have been deblocked and their data is available for other tiles that are data dependent on either or both of these tiles, namely T_{0,2}, which is data dependent on T_{0,1}, and T_{1,0} which is data dependent on T_{0,0} and T_{0,1}. Thus, T_{0,2} and T_{1,0} can now be deblocked.

At time t=3, T_{0,3} and T_{1,1} can be deblocked. Continuing this logic will provide the reference deblocking time for each tile in the frame. For example, at t=8, five tiles, T_{0,8}, T_{1,6}, T_{2,4}, T_{3,2}, and T_{4,0}, can be deblocked in parallel.

For a frame of any size the reference deblocking time for the first row is sequential. This means that the reference deblocking time for a tile T_{0,i} is equal to the reference deblocking time of the previous deblocked tile in the same row, T_{0,i-1}, plus one reference time unit. For instance, if the reference deblocking time is one reference time unit for T_{0,0} then the reference deblocking time for the next tile in the row, T_{0,1}, is two reference time units since one reference time unit plus the reference time of T_{0,0} is two reference time units.

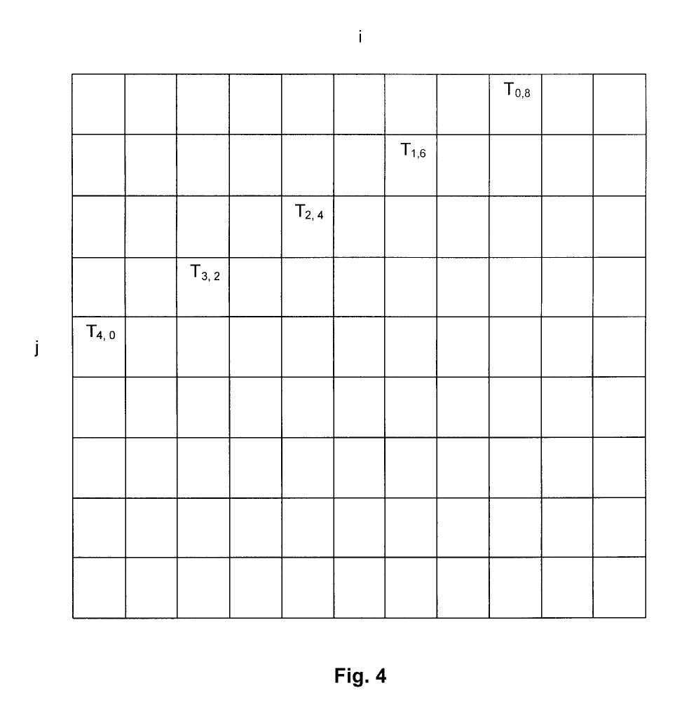

For the tiles in the following rows, the reference deblocking time T_{j,i} is equal to two reference time units plus the reference deblocking time for T_{j-1,i} because of the data dependency of tile T_{j,i} on the pixel data of tiles T_{j-1,i} and T_{j-1,i+1} since T_{j,i} cannot be deblocked until these two tiles have been deblocked. Therefore, the reference deblocking time of a tile T_{j,i} is the same as the reference deblocking time of T_{j-1,i+2}. A diagonal row of tiles may be formed for a tile T_{0,i} on the first row with the sequence of tiles T_{1,i-2}, T_{2,i-4}, T_{3,i-6}, . . . for all tiles in this sequence that are in the frame. These diagonal rows are all tiles that can be deblocked in parallel if there are enough hardware resources. For instance, FIG. 4 illustrates one of these diagonal rows for a frame with 9×11 tiles that may be deblocked in parallel.

In reality, hardware resources are limited. To facilitate the assigning of tiles to different hardware resources, a scheduling index for each tile can be developed such that some mapping can be designed to map the scheduling index to a hardware resource. A schedule index, S_{j,i}, for each tile T_{j,i}, can be developed as a function of its reference deblocking time. Note that S_{j,i} represents the scheduling index for the associated tile T_{j,i}. Multiple tiles having the same reference deblocking time can be arbitrarily assigned different scheduling indices such that every tile in the frame has a unique scheduling index. The scheduling index provides an order or schedule that the tiles may be deblocked. The scheduling index may also be a function of the hardware availability for parallel processing at any one time. To avoid scheduling conflicts, each tile should be given a distinct scheduling index so that no two tiles will be assigned to the same hardware resource at the same time.

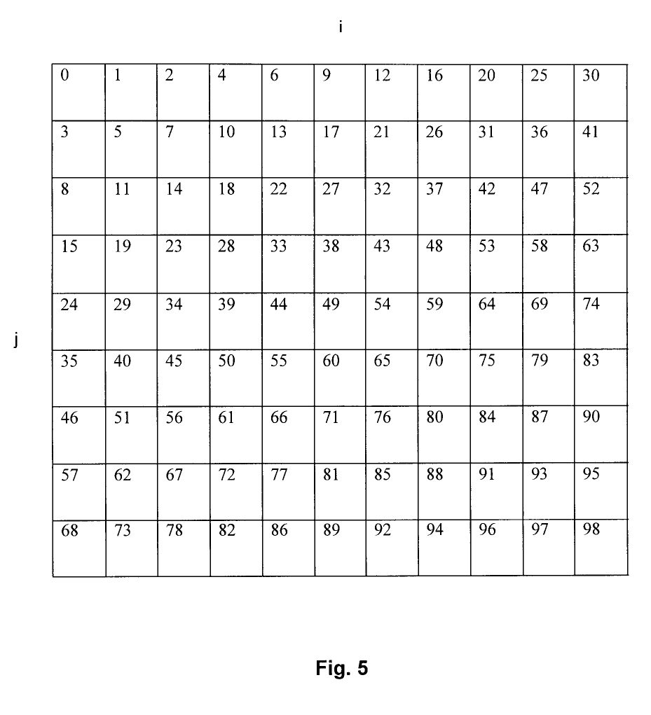

FIG. 5 illustrates a frame with 9×11 tiles, where the number inside each tile represents the scheduling index, S_{j,i}, for that tile. The scheduling index S_{0,0} is 0 since it is the first to be deblocked. Since no other tiles may be deblocked in parallel, only one hardware resource is needed at this time. The scheduling index S_{0,1} is 1 since it is the second tile to be deblocked and likewise only one hardware resource is necessary at time t=1. At time t=2, two tiles, T_{0,2} and T_{1,0}, can be deblocked in parallel if there are available hardware resources. Therefore, S_{0,2} may be assigned to be 2 and S_{1,0} may be assigned to be 3, where both can be deblocked in parallel by utilizing the data dependency. Similarly S_{0,3} is assigned a scheduling index of 4 and S_{1,1} is assigned a scheduling index of 5, where both may also be deblocked in parallel by utilizing the data dependency. These two tiles can be processed in parallel if there are available hardware resources or can be processed sequentially in the order of its associated scheduling index if there are not enough available hardware resources for the parallel deblocking of these tiles.

Following this algorithm, a schedule with scheduling indices for a frame can be calculated. The tiles in the first row can be used sequentially to generate diagonal rows of sequentially indexed tiles that may be deblocked in parallel by utilizing the data dependency of a frame. Thus, the tiles in a frame can be scanned diagonally, as shown in FIG. 5, to generate the scheduling index for each tile. A diagonal row of tiles may be formed for a tile T_{0,i} on the first row with the sequence of tiles T_{1,i-2}, T_{2,i-4}, T_{3,i-6} . . . for all tiles in this sequence that are in the frame.

These diagonal rows are all tiles that can be deblocked in parallel if there are enough hardware resources. The index of the tiles in a diagonal row may be increased by 1 for each tile in the sequence indicating the order that these tiles should be deblocked in parallel if there are available hardware resources or in sequence if there are not. T_{0,2} and T_{1,0} form a diagonal row, and if the scheduling index for T_{0,2} is 2, then the scheduling index for T_{1,0} is 3. Similarly, T_{0,5}, T_{1,3}, T_{2,1} form a diagonal row and their scheduling indices are 9, 10, and 11 respectively.

Other variations for calculating the scheduling indices for the tiles of a frame may be used. For example, the scheduling indices for tiles that can be processed in parallel may be interchangeable where there are enough hardware resources to process them in parallel. Additionally, scheduling indices may not have to be increased by 1 for each tile. The scheduling indices may be all even numbers and may be increased by 2. The ways to represent the scheduling indices are limitless.

If there are a limited number of hardware resources, the tiles can be assigned to hardware resources based on a mapping from scheduling index to hardware resource identity number. There exist many possible mappings. The following is a simple example of such mapping. If the number of hardware resources is equal to M and these hardware resources are numbered as 0, 1, . . . M−1, then, one method of assignment is to assign a tile with a scheduling index m to hardware resource number with the resulting number of m mod M, where mod may be defined as the modulo operation that finds the remainder of m divided by M. For example, if there are 3 hardware resources, the tile with a scheduling index of 20 will be deblocked by hardware numbered 2 since 20 mod 3 is equaled to 2.

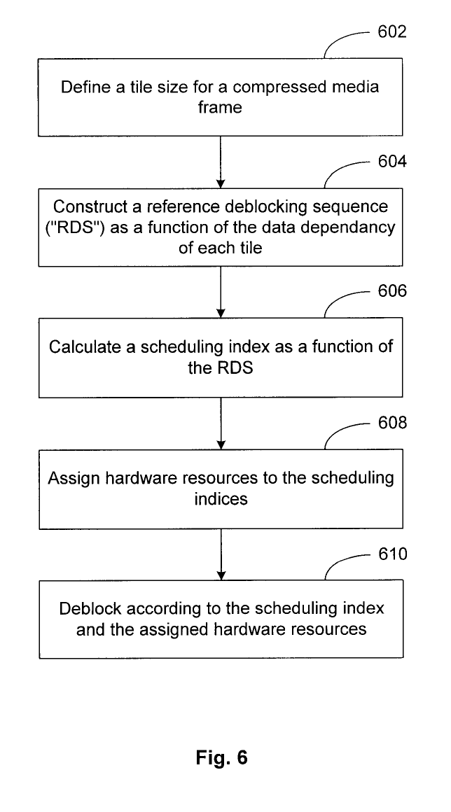

FIG. 6 is a process flow for a method of this invention for statically scheduling the parallel deblocking of the tiles of a frame. In the preferred method, a tile size can be defined 602 to be one macroblock or one macroblock pair. The reference deblocking sequence is then estimated as a function of the data dependency of each tile 604. Next, a scheduling index is calculated as a function of the reference deblocking sequence 606, and the indices of the scheduling index are assigned to be processed by the hardware resources 608 as described above. Finally, deblocking of tiles can begin 610 following the order defined by the scheduling indices and using the hardware assigned for that tile.

The elegance of static scheduling is its simplicity. However, deblocking of different tiles may take different lengths of time due to the different conditions of each tile and its neighbors. In static scheduling, each tile is statically tied to a specific hardware resource. When a hardware resource has finished the deblocking of its assigned tile, there may be other tiles available for deblocking that have not been assigned to this idle hardware. Static scheduling does not allow the idle hardware to process these available tiles that are ready and waiting. Instead, the idle hardware resource waits until the next tile that it is statically assigned to is ready for deblocking. Therefore, static scheduling may not provide the most efficient or speedy deblocking scheme since there may be times when one or more hardware resources are idling while other tiles are waiting to be deblocked.

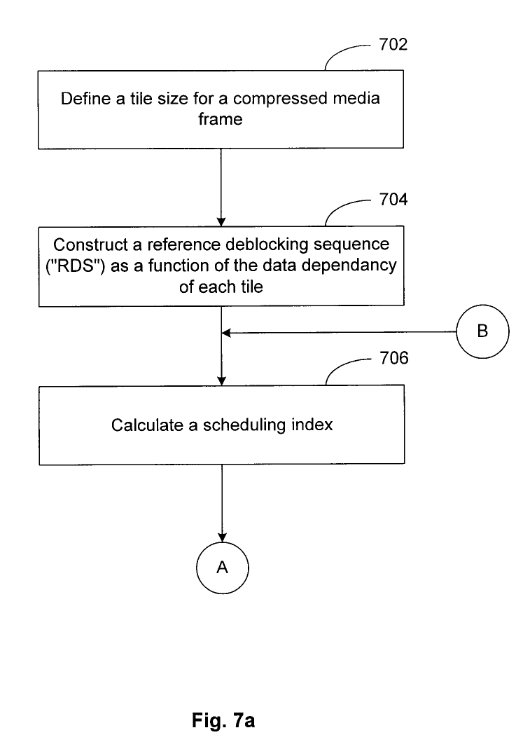

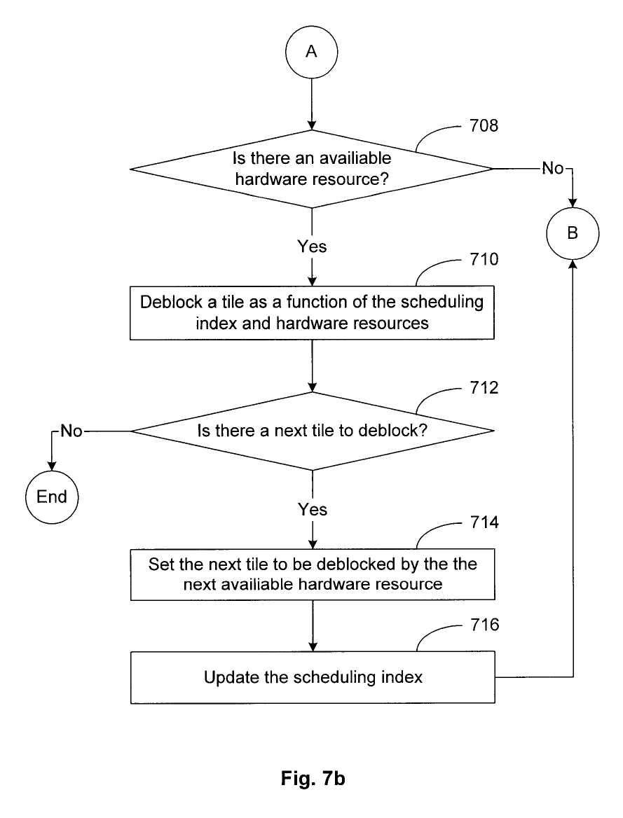

A method of this invention for parallel deblocking provides for dynamic scheduling to overcome the disadvantages of static scheduling. FIGS. 7a-7b illustrate a process flow for dynamically scheduling parallel deblocking of the tiles of a frame. Here, similarly to static scheduling, a tile size is defined 702 for a frame. Next, a reference deblocking sequence is constructed 704 as a function of the data dependency of each tile. The scheduling index is then selected 706 as a function of the reference deblocking sequence.

However, unlike the method for static scheduling, the scheduling indices are not assigned to specific hardware. Instead, when a hardware resource becomes available 708, the hardware resource deblocks a tile 710 as a function of the scheduling index and the one or more hardware resources. Next, the scheduling index is searched for the next tile to be deblocked 712. If all the tiles have been deblocked, then there is no need to continue assigning the one or more hardware resources. Thus, the dynamic scheduling process is completed.

If a next tile does exist, then set the next tile to be deblocked by the next available hardware resource 714. The scheduling index is then updated 716 and recalculated 706. Dynamic scheduling continues in this loop until all the tiles have been deblocked.

Dynamic scheduling eliminates the disadvantage of having idle hardware resource but pays the price in increased complexity. Special resource, either hardware or software, is needed to serialize the allocations of tiles to hardware resources such that the same tile will not be assigned to multiple hardware resources for unnecessary redundant deblocking.

To speed up the searching of an available tile in dynamic scheduling, special measures may be taken to avoid scanning the entire scheduling index space. One preferred method is to maintain a lowest scheduling index, Iₛᵢ, and a highest reference deblocking time, hₜₘ, for the tiles currently being deblocked, such that a search can begin with the tile having the current Iₛᵢ and stops at the tile having a reference deblocking time greater than or equal to hₜₘ plus 2. The two variables Iₛᵢ and hₜₘ need to be updated with the completion of each tile 718. Tiles with a reference deblocking time greater than or equal to hₜₘ plus 2 will not be available for deblocking since tiles with reference deblocking time equal to hₕₜₘ plus 1 have not yet been deblocked. If an available tile can be found, it will be assigned to the hardware resource. Otherwise, either all tiles have been processed or the hardware resource needs to wait for more tiles to be deblocked before any tile is available for deblocking.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A method for parallel deblocking of a frame having a plurality of tiles wherein each of said tiles having a data dependency on zero or more of said tiles, comprising the steps of:
constructing a reference deblocking sequence for the processing of said tiles as a function of the data dependency of each respective tile;
calculating scheduling indices for said tiles as a function of said reference deblocking sequence; and
deblocking said tiles in accordance with said scheduling indices.

2. The method of claim 1 wherein one or more hardware resources are available for said deblocking and wherein, after said calculating scheduling indices step, each respective tile is assigned to one of said hardware resources as a function of its scheduling index and the number of available hardware resources available for deblocking.

3. The method of claim 1 wherein static scheduling is employed in assigning a tile to a hardware resource in accordance with its respective scheduling index.

4. The method of claim 2 wherein static scheduling is employed in assigning a tile to one of said hardware resources in accordance with its respective scheduling index.

5. The method of claim 1 wherein dynamic scheduling is employed in assigning said tiles to one or more hardware resources in accordance with the scheduling indices.

6. The method of claim 2 wherein dynamic scheduling is employed in assigning said tiles to said hardware resources in accordance with the scheduling indices.

7. The method of claim 5 wherein a lowest scheduling index is maintained for a tile currently being deblocked.

8. The method of claim 7 wherein a highest reference deblocking time is maintained for a tile currently being deblocked.

9. The method of claim 8 wherein the lowest scheduling index and the highest reference deblocking time define a search range for searching the next available tile for deblocking.

10. The method of claim 1 wherein each tile having a data dependency on zero to three of neighboring tiles.

11. The method of claim 5 wherein in dynamic scheduling, the scheduling indices are recalculated as a function of said reference deblocking sequence and one or more deblocked tiles.

12. The method of claim 6 wherein in dynamic scheduling, the scheduling indices are recalculated as a function of said reference deblocking sequence and one or more deblocked tiles.

13. A method for parallel deblocking of a frame having a plurality of tiles wherein each tile having a data dependency on zero or more neighboring tiles, comprising the steps of:
constructing a reference deblocking sequence for the processing of said tiles as a function of the data dependency of each respective tile;
calculating scheduling indices for said tiles as a function of said reference deblocking sequence;
assigning one or more hardware resources to each of said tiles as a function of the scheduling index of the respective tile and the number of available hardware resources available for deblocking when processing the respective tile; and
deblocking said tiles in accordance with said scheduling indices.

14. The method of claim 13 wherein static scheduling is employed in assigning a tile to a hardware resource in accordance with its respective scheduling index.

15. The method of claim 13 wherein dynamic scheduling is employed in assigning said tiles to one or more hardware resources in accordance with the scheduling indices.

16. The method of claim 15 wherein a lowest scheduling index is maintained for a tile currently being deblocked.

17. The method of claim 16 wherein a highest reference deblocking time is maintained for a tile currently being deblocked.

18. The method of claim 17 wherein the lowest scheduling index and the highest reference deblocking time define a search range for searching the next available tile for deblocking.

19. A method for parallel deblocking of a frame having a plurality of tiles wherein each tile having a data dependency on zero to three neighboring tiles, comprising the steps of:
constructing a reference deblocking sequence for the processing of said tiles as a function of the data dependency of each respective tile;
calculating scheduling indices for said tiles as a function of said reference deblocking sequence;
assigning one or more hardware resources to each of said tiles as a function of the scheduling index of the respective tile and the number of available hardware resources available for deblocking when processing the respective tile, wherein dynamic scheduling is employed;
deblocking said tiles in accordance with said scheduling indices; and
recalculating said scheduling indices as a function of said reference deblocking sequence and one or more deblocked tiles;
wherein a lowest scheduling index and a highest reference deblocking time are maintained for defining a search range for searching the next available tile for deblocking.
